(19) United States
(12) Patent Application Publication
(10) Pub. No.: US 2022/0366331 A1
(43) Pub. Date: Nov. 17, 2022

(54) PERSONA-DRIVEN ASSISTIVE SUITE

(71) Applicant: SAP SE, Walldorf (DE)

(72) Inventors: Sujith Prathap, Bangalore (IN); Sagar Gupta, Kalka (IN)

(21) Appl. No.: 17/320,692

(22) Filed: May 14, 2021

(51) Int. Cl. G06Q 10/06; G06F 40/211; G06N 5/02; G06F 40/295; G06N 20/00

(52) U.S. Cl. CPC G06Q 10/0633; G06F 40/211; G06N 5/02; G06F 40/295; G06N 20/00

(57) ABSTRACT

In an example embodiment, machine learning is utilized to provide a persona driven assistive suite, which aids users in completing software workflows using information about the context of the desired outcome. A specialized natural language processing system is able to parse and understand requests from users. This understanding is then combined with information about a user to obtain or derive a software workflow specific for the user and the desired outcome.

### TECHNICAL FIELD

This document generally relates to machine learning. More specifically, this document relates to using machine learning for a persona driven assistive suite.

### BACKGROUND

Users today are inundated with and exposed to a large number of different software solutions, each with their own workflows that need to be followed in order to accomplish a task. This can be very difficult for users, especially when they are trying out new software or new features of existing software, as users are often at a loss as to how to accomplish a task in the new software or feature. Users commonly will get lost, frustrated, or even give up on using the software or feature because there is no proper guidance as to how it should be used to accomplish the particular tasks important to the user. Fundamentally, they fail to understand a user's challenge for the given task, which is needed for user context-aware product support.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a persona-driven assistive suite system, in accordance with an example embodiment.

FIG. 2 is diagram illustrating an interaction graph, in accordance with an example embodiment.

FIG. 3 is a diagram illustrating a natural language processor, in accordance with an example embodiment.

FIG. 4 is a flow diagram illustrating a method of creating a virtual workflow, in accordance with an example embodiment.

FIG. 5 is a flow diagram illustrating a method for the execution of a virtual workflow or preliminary workflow, in accordance with an example embodiment, in more detail.

FIG. 6 is a diagram illustrating a screen capture of a user interface having a pop-up window describing issues with the workflow that the user needs to remedy, in accordance with an example embodiment.

FIG. 7 is a diagram illustrating a screen capture of a user interface having a pop-up window allowing the user to enter more account settings, in accordance with an example embodiment.

FIG. 8 is a diagram illustrating a screen capture of a user interface having a pop-up window allowing the user to enter additional account settings, in accordance with an example embodiment.

FIG. 9 is a diagram illustrating a screen capture of a user interface having a pop-up window describing the remaining issue, in accordance with an example embodiment.

FIG. 10 is a diagram illustrating a screen capture of a user interface where the user can enter additional missing information.

FIG. 11 is a block diagram illustrating a software architecture, which can be installed on any one or more of the devices described above.

FIG. 12 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Solutions for the problem described in the background section have to this point only come in the form of non-context aware product support, such as bots. Bots are scenario-specific, but still lack the context needed to provide context-specific support. What is needed is a solution that solves this technical issue.

In an example embodiment, machine learning is utilized to provide a persona driven assistive suite, which aids users in completing software workflows using information about the business context mapping for the user to achieve the desired outcome. A specialized natural language processing system is able to parse and understand requests from users. This understanding is then combined with information about a user to obtain or derive a software workflow specific for the user and the desired outcome.

While this solution may be utilized in a variety of different types of software systems, it can be especially helpful in business systems, where workflows are typically complicated due to additional software steps needed to perform a particular task and people other than the user who may need to be also involved in completing the workflow. For example, a user may be an employee wishing to requisition a new piece of computer equipment. The specific workflow for accomplishing this may include not just a series of steps the user may need to complete, such as identifying the particular piece of computer equipment, ordering it, scheduling delivery and installation, and so forth, but also may include a need for others to provide input, such as a supervisor providing approval for the purchase or an installer identifying open installation appointments.

The solution provides a business context user-aware workflow that can then be used in a variety of different ways depending upon a user interface operated by the user. In one example embodiment, a voice-controlled virtual assistant may be utilized, and the business context user-aware workflow may provide the prompts that the voice-controlled virtual assistant may use to query a user to speak information used to address the corresponding prompts. For example, at an appropriate point in the workflow, the voice-controlled virtual assistant may ask the user to provide a shipping address, at which point the user can speak a shipping address, which the workflow may then use to fill in a shipping address field in the workflow. In another example embodiment, a manually-controlled user interface may be used that does not prompt the user for information but instead is utilized once the user enters information to validate that the user has submitted valid information. For example, the workflow may be used to validate that what the user entered in a shipping address field is a valid shipping address (e.g., it actually is a shipping address that exists in an address database).

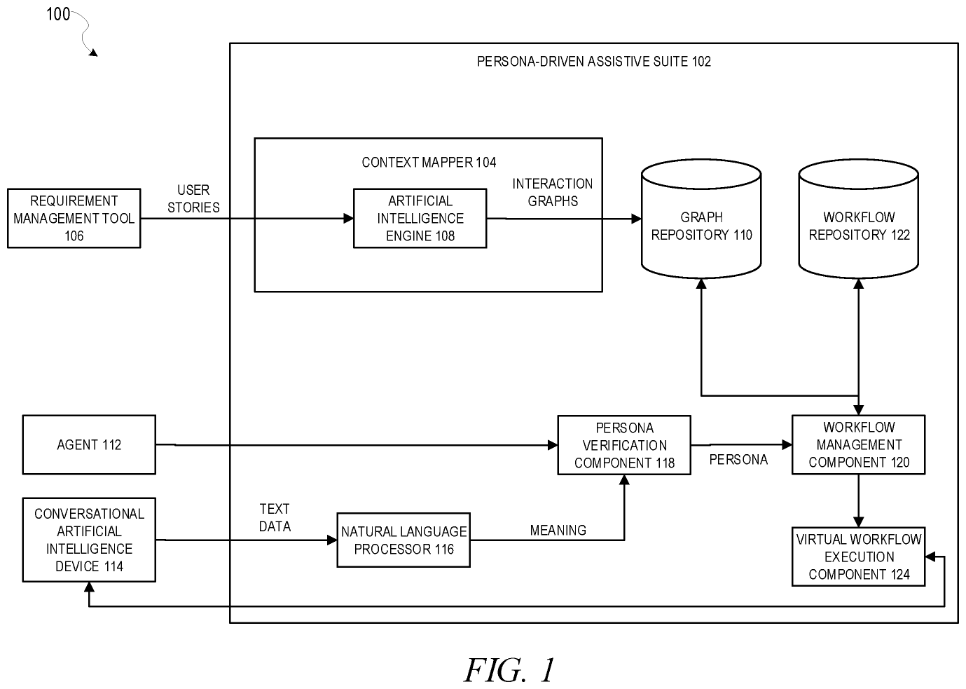

FIG. 1 is a block diagram illustrating a persona-driven assistive suite system 100, in accordance with an example embodiment. The persona-driven assistive suite system 100 includes a persona-driven assistive suite 102. A context mapper 104 within the persona-driven assistive suite 102 creates graphs of possible interactions using data from one or more requirement management tools 106. More particularly, an artificial intelligence engine 108 in the context mapper 104 scans the one or more requirement management tools 106 or “user stories” or the like. A user story is an informal, natural language description of one or more features of a software system and captures a description of a software feature from an end-user perspective. It describes the type of user, what they want, and why. In some example embodiments, these questions may be expanded to the 6 Ws, namely Who, What, Why, Where, When, and How. A linked graph for all possible user interactions may be generated.

User stories are also the building blocks of larger frameworks such as epics and initiatives. Epics are large work items broken down into a set of stories, and multiple epics comprise an initiative.

User stories may be expressed in a simple sentence structure, such as “As a [persona], I [want to], [so that],” although this structure is not required.

In an example embodiment, the user stories contain interactions of the user with a system and guide a team as to what is expected out of the specific user case or feature by providing the 6 Ws. The artificial intelligence engine 108 automatically scans these user stories to identify the user actions and thereby identify all the possible steps and their interactions with each other, or any other dependencies. The artificial intelligence engine 108 then stores this information as a graph in a graph repository 110. The “who” that is extracted from a user story represents a subject, although at a broad level (e.g., a group of users as opposed to an individual user). It may be saved as a persona. These personas may include, for example, business roles such as “procurement officer” or “approver” but also can include more general roles such as “casual user.”

There may be a different artificial intelligence engine 108 trained for each particular experience (e.g., “procurement to pay” or “hire to retire”). The artificial intelligence engine 108 is trained to parse the user story and identify the 6 Ws from the story. For example, for the “procurement to pay” experience, the artificial intelligence engine parses the user story to identify a “who” (e.g., “casual user,” “procurement officer,” “approver,” or “supplier”); “what” (which operations the user can perform, such as create purchase requests or approve a budget allocation to identify one or more experiences); “why” (why the user needs to perform the action(s), such as because of their role needs or due to a business process; “when” (when it will be triggered, whether manually triggered or time-based); “where” (a location where the operation will take place); and “how” (how the user can perform the action(s), such as if the operation has some prerequisite, like needing to know overall budget availability for budget approval).

The artificial intelligence engine 108 may be a machine learned model trained by a machine learning algorithm using training data. This training data may include, for example, user stories along with labels applied to various portions of the user stories identifying the 6 Ws, which allows the machine learning algorithm to learn what features of the user stories are indicative of each of the 6 Ws. The machine learning algorithm may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method.

One or more rules may be stored for how to construct an interaction graph based on the extracted 6 Ws, and the artificial intelligence engine 108 may take these rules and apply them to the extracted 6 Ws to form the interaction graph.

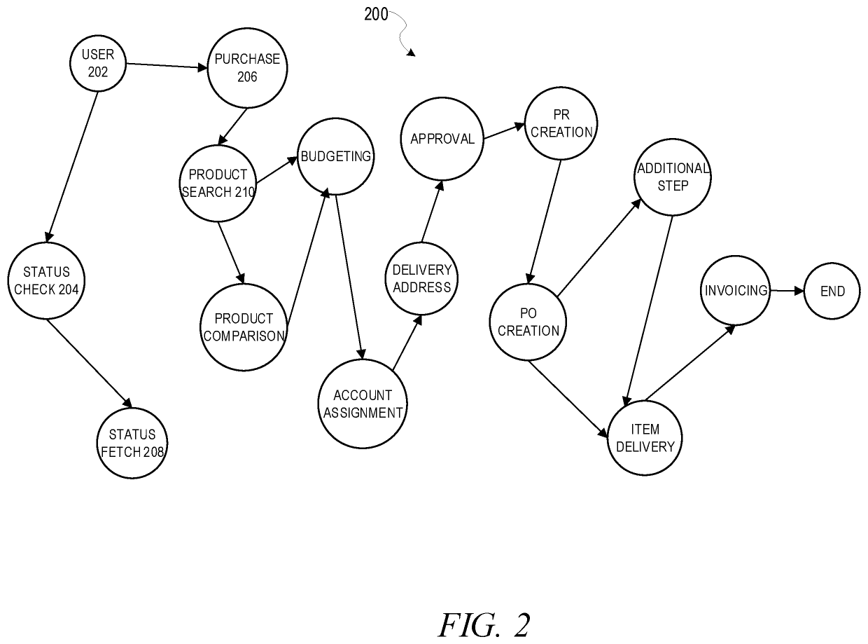

FIG. 2 is diagram illustrating an interaction graph 200, in accordance with an example embodiment. Here, a user 202 may initially take two possible interaction paths; one path is to request a status check 204 and the other is to request a purchase 206. The nodes in the interaction graph 200 represent entities (such as users), requests, or data, with the edges between nodes representing interactions that may occur. In response to a status check 204 request, for example, the system may perform a status fetch 208 command. In response to a request for a purchase 206, the system may provide a product search 210. In some cases, there is only one path (edge) from a node, while in other cases, there are multiple paths to choose from.

Referring back to FIG. 1, a user may install an application for a specific experience on their device. This application is known as an agent 112. To perform this, the user may log in and provide user information such as user name, email address, preferences, and user data (such as role, delivery address, manager name, cost center, etc.). This user data could also be fetched from a company Human Resources (HR) database. The roles may be useful in later establishing a persona for the user. Each application (such as procurement) may have different roles (e.g., Buyer, Approver, Purchasing Officer). The persona may be defined at any level of granularity. For example, the persona may specify the exact user, a group of users, or a job title.

The context mapper takes voice commands as input from a conversational artificial intelligence device 114. The voice commands include at least one request. The request may actually be generated by the conversational artificial intelligence device 114 in response to operation of a software agent, such as a software application (“app”) operating on a computing device that either also runs the conversational artificial intelligent device 114 or interacts with it. For example, in some example embodiments, the conversational artificial intelligent device 114 is actually implemented as both a client and a server application, with the client application operating on a computing device, such as a mobile device or stand-alone conversational intelligent device, and the server application operating on a remote server. The server application in that implementation may perform the bulk of the processing of voice data and its conversion into text-based data. Regardless of implementation, however, text-based data that has been converted from voice data may be passed to the context mapper 104 in the form of a request.

Along with the request, the context mapper 104 may also obtain information about the user and/or agent the user is operating. For example, the context mapper 104 may identify a job title (e.g., project manager, procurement officer, junior programmer) for the user and a location for the user, and also may identify a software program that the user is operating when the request is generated (e.g., procurement software, management software, sales software). Using a combination of this information about the user and/or agent and the text data from the converted voice data, the context mapper 104 is able to map to a particular context.

A context encompasses an understanding of the factors impacting what the user is attempting to accomplish from various perspectives, including how decisions are made. More particularly, the set of all possible interactions that the user's request can launch may be identified, as well as the users that are involved in these possible interactions. Using this projection, a persona-specific context may be identified. This context is used when validating, executing, and assisting virtual workflows that are created dynamically.

Furthermore, in an example embodiment, a natural language processor 116 may also be utilized. The natural language processor 116 is a machine-learned model that is specifically trained for the agent that the user is using. The goal of the natural language processor 116 is to identify the meaning of the text data, which may vary based on the context. For example, a request stating “I wish to purchase mobile phones” may have a different meaning if the user is a product manager operating a procurement tool than if the user is a junior programmer operating a requisition portion of an internal communications application. The natural language processor 116 outputs at least a subject, a command, and an object. The subject is the entity performing the command, such as a user. The command is an indication of the process to be performed. The object is the thing on which the command is performed. For example, if the text data “I wish to purchase mobile phones” is received, the subject is “I” (the user, whose data can be obtained from a user profile), the command is “purchase,” and the object is “mobile phones.”

Once this meaning is known, a persona verification component 118 takes this meaning and verifies a persona based on the user and the agent. This persona is passed to a workflow management component 120. The workflow management component 120 determines if a virtual workflow already exists for this persona and the desired goal of the command, as determined by the natural language processor 116. If so, this virtual workflow is retrieved. If not, then the workflow management component 120 accesses the graph repository 110 to identify nodes corresponding to the user (such as those corresponding to the user's role), the agent (such as nodes in graphs particularly pertaining to the agent), and desired goal of the command (e.g., purchase a product), in an interaction graph in the graph repository. The nodes and edges between these graphs may also be retrieved and a preliminary workflow may be established based on these nodes and edges. Every node would have certain criteria or rules which would be used to check whether the node is required to be part of the workflow or not. For example, one rule might be that for an approval node to be part of the workflow, the amount of the object should be greater than 1000$. In another example, an organization may set up a rule that all purchases over $1000 need manager approval, but those of $1000 or less can get automatic approval.

The preliminary workflow may then be executed by a virtual workflow execution component 124, prompting the user for selections and/or additional information as needed (via the conversational artificial intelligence device), and prepopulating fields with information from the user's data (e.g., delivery address) when appropriate.

Once completed, the preliminary workflow becomes an official virtual workflow and can be saved in the workflow repository 122. This allows the virtual workflow to be reused when the user performs the same or similar command in the future. Thus, for example, if the user wishes to perform the same action (such as purchase) on an item from the same catalog (e.g., another mobile device, or a computer in the same catalog as the mobile device), then the same virtual workflow can be retrieved and used, eliminating the need for the persona-driven assistive suite 102 to construct a virtual workflow from scratch each time a command is received. Thus, in the case where the workflow management component 120 determines that a virtual workflow already exists for this persona and the desired goal of the command, the retrieved virtual workflow is executed in the same manner as the preliminary workflow, with the exception of not saving it in the workflow repository 122, since it was already saved there.

Referring specifically to the natural language processor, in the field of computing, Natural Language Processing is a field concerned with the interactions between computers and human (e.g., natural) languages. Natural language generation systems convert information from computer databases into readable human language. The term “natural language” is used to distinguish human languages from computer languages (e.g., C++ or Java). In natural language processing, information extraction is a type of information retrieval, whose purpose is to automatically extract structured information from unstructured machine-readable documents. A broad goal of the information extraction is to allow computation to be done on the previously unstructured data. A more specific goal is to allow logical reasoning to draw inferences based on the logical content of the input data. More specifically, information extraction allows natural language processing to include tasks such as named entity recognition, terminology extraction, and relationship extraction. The named entity recognition locates and classifies atomic elements in text into predefined categories such as the names of persons, organizations, locations, expressions of times, quantities, and so on.

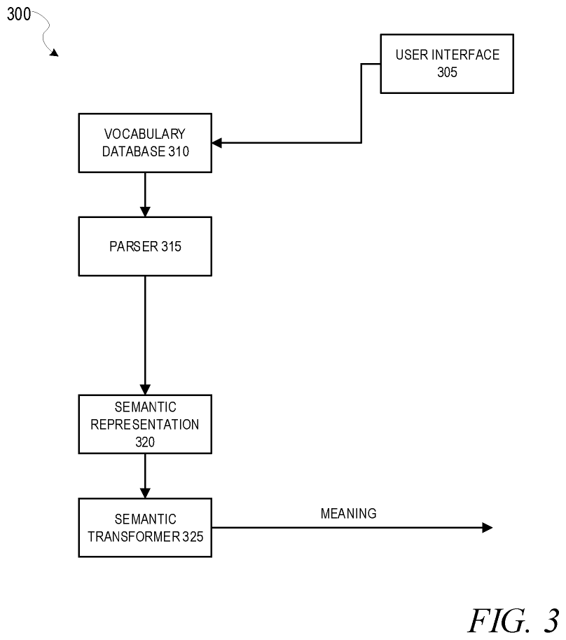

Referring to FIG. 3, further example implementation details of a process flow for natural language processing are shown in illustration 300. In some embodiments, the text data request may be worded in natural (or ordinary) language, including having a grammatical and syntactical structure that the user would use in any ordinary conversation. For example, a user may have spoken the phrase “I would like to purchase mobile devices.” In some example embodiments, the text data request may be a question, such as “how do I purchase mobile devices?” although questions themselves may not be phrased in the form of a typical question with a question mark. For example, the same question could be phrased in the form of “Please show me how to purchase mobile devices.”

The text data request may be supplied to a vocabulary database 310. The vocabulary database 310 may be customizable and may include a vast array of definitions and relationships, perhaps not unlike a vocabulary a human may know and understand. For example, the vocabulary database 310 may include many root or base definitions, as well as many synonyms and antonyms that may link or connect relationships of many words together. In some embodiments, the database 310 may be viewed or referred to as a lexicon database. The vocabulary database 310 may specify the types of entities that exist in a particular domain (e.g. “debt,” “company,” “enterprise,” “time-entity,” etc.), the words that constitute these entities (e.g., debt(EN)==debt(ENTITY), month(EN)=time-entity(ENTITY), etc.), and the abstract relationships that hold between different entities (e.g., company entities relate to debt entities since companies have debts, debt entities relate to time entities since debts have durations). In an example embodiment, there may be a different vocabulary database 310 for each agent a user could use while generating the request, and the system could choose to use the vocabulary database corresponding to the particular agent being used by this particular user.

Natural language parser 315 may utilize vocabulary database 310 in order to parse the query from a user interface 305. The parser 315 may follow predefined rules of grammar and syntax for the natural language the query is written in. For example, the parser 315 may identify verb to subject relationships, subdivide the query into appropriate clauses based on identified conjugations and declensions, and so on. Thus, the natural language parser 315 may rewrite and/or store the user's request as a semantic representation 320, which may be in a format better organized for the natural language processor. In some embodiments, the semantic representation 320 provides a description of the request, including the logical relations and the connectives and quantifiers that relate them. In some example embodiments, the parser may be a bottom-up syntactic chart parser; i.e., it may use dynamic programming and a syntactic grammar to search, from the words up, for all possible grammatical relations that hold between subspans (e.g., words, phrases) in a given language input. Alternative techniques/parsing strategies could also be used (e.g., top-down parsing strategy, a probabilistic parser that may perform pruning, etc.).

In general, the parser 315 may use the entity and relation information from the vocabulary database 310 to prune the results of the parser, and find/rewrite syntactic patterns to semantic patterns that are part of the target logical form. Take, for example, the sentence “I would like to send an email to a company with a debt from last year.” It should be noted that this sentence has an ambiguity, in that it is not clear whether “from last year” is modifying “a debt” or “a company” (i.e., whether the debt is from last year, or it is a company that existed last year). The syntactic parser 315 may find grammatical patterns between [Company (from last year)] and [debt (from last year)], knowing that there is a relationship between debt(=DEBT) and last year(TIME-ENTITY) from the lexicon/vocabulary database 310. This may allow the parser 315 to prune out the first possibility (i.e., [company (from last year)]), and keep the second (i.e., [debt (from last year)]) when parsing. Once such patterns are found, the patterns can be mapped onto semantic relations (e.g., debt-has-duration), which may form the basis of the logical form. Example mechanisms for pruning results of the parser with the vocabulary database 310 may range from purely rule-based systems to ones that use machine learning, such as neural networks, and embodiments are not so limited.

The semantic representation 320 of the user's request may then be transformed into a logical format via semantic transformer 325. In some embodiments, this transformation may include a number of stages. For example, the natural language query may be parsed into a parse tree, which may then be transformed into a semantic representation. Then, the semantic representation may be translated into a logical form, in that the semantic representation may be converted into a string of words and other symbols (e.g., brackets, parentheses, colons) that captures the meaning of the query expressed in a reliable logical form.

In an example embodiment, the parser 315 may be a machine learned model trained, by a machine learning algorithm using training data, to parse natural language text to identify a meaning of the natural language text. In some example embodiments, each agent 112 will have its own dedicated machine learned model in the parser 315 that is trained specifically to parse text data associated with that agent 112. The machine learning algorithm used for training the agent-specific natural language processor may be selected from among many different potential supervised or unsupervised machine learning algorithms. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method. Here, the training data may include sample text data that has been labeled with meanings, and the machine learning algorithm trains the model to identify which features of text data influence its meaning, assigning weights to each of these features through the training process.

Here the weights learned may be weights applied to features of input text and may be learned by the machine learning algorithm trying different weights, and then examining the results of a loss function applied to a score produced by applying the weights to a particular piece of training data. If the loss function is not satisfied, the machine learning algorithm adjusts the weights and tries again. This is repeated in a number of iterations until the loss function is satisfied, and the weights are learned.

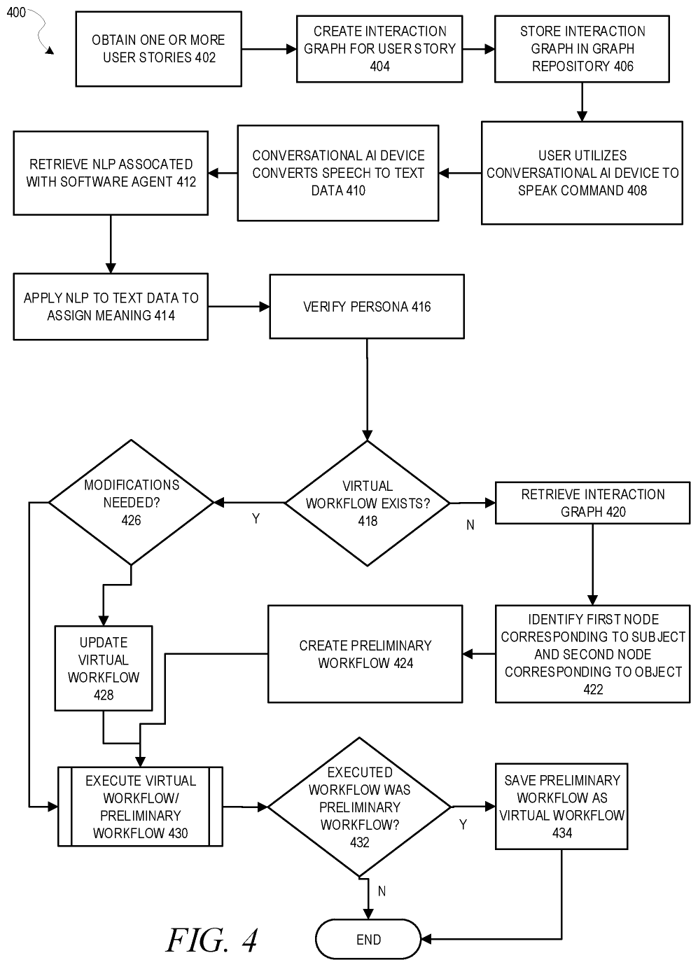

FIG. 4 is a flow diagram illustrating a method 400 of creating a virtual workflow, in accordance with an example embodiment. At operation 402, one or more user stories are obtained from a requirement management tool. A user story is an informal, natural language description of one or more features of a software system, and includes a subject, a command, and an object on which the command is to be applied. The subject is a user. This represents context for the user story.

At operation 404, an interaction graph is created for the user story. The interaction graph is a graph that includes nodes and edges, with each node representing an entity. The entities may include the subject and the object, as well as potentially other users and other objects. The edges represent interactions between the entities that, when performed, accomplish the command. The interaction graph may be created using an artificial intelligence engine that is specifically trained for a particular software agent.

At operation 406, the interaction graph is stored in a graph repository.

Thereafter, at operation 408, a user utilizes a conversational artificial intelligence device to speak a command. This command is associated with a software agent run by the user. In some example embodiments, the conversational artificial intelligence device operates on the same device as the software agent, while in other example embodiments, they operate on separate devices and the user is associated with each. At operation 410, the conversational artificial intelligence device converts the spoken command to text data, specifically natural language text data. At operation 412, a natural language processor associated with the software agent is retrieved. At operation 414, the natural language processor associated with the software agent is applied to the natural language text data to assign a meaning to the natural language text data, the meaning including at least a subject, a command, and an object to which the command applies.

A persona corresponding to the subject from the natural language text data is verified (see operation operation 416). At operation 418, it is determined if a virtual workflow exists corresponding to this persona, command, and object from the natural language text data. If not, then at operation 420, the persona, and the command from the natural language text data, are used to retrieve an interaction graph from the graph repository. This interaction graph may or may not be the one created in operation 404. At operation 422, a first node corresponding to the subject and a second node corresponding to the object are identified in the obtained interaction graph. At operation 424, a preliminary workflow including the first node and the second node and also containing all nodes and edges between the nodes corresponding to the subject and the object in the obtained interaction graph is created.

If at operation 418 it is determined that a virtual workflow already exists for the persona, command, and subject, then at operation 426, it is determined if any modifications to the virtual workflow are needed. Such modifications might be needed if, for example, company policies have changed in a manner that might affect the virtual workflow. One example would be if a company decided to change their requisition policy so that the threshold amount when manager approval is needed is $1500 instead of $1000. If a modification is needed, then at operation 428, the virtual workflow is updated.

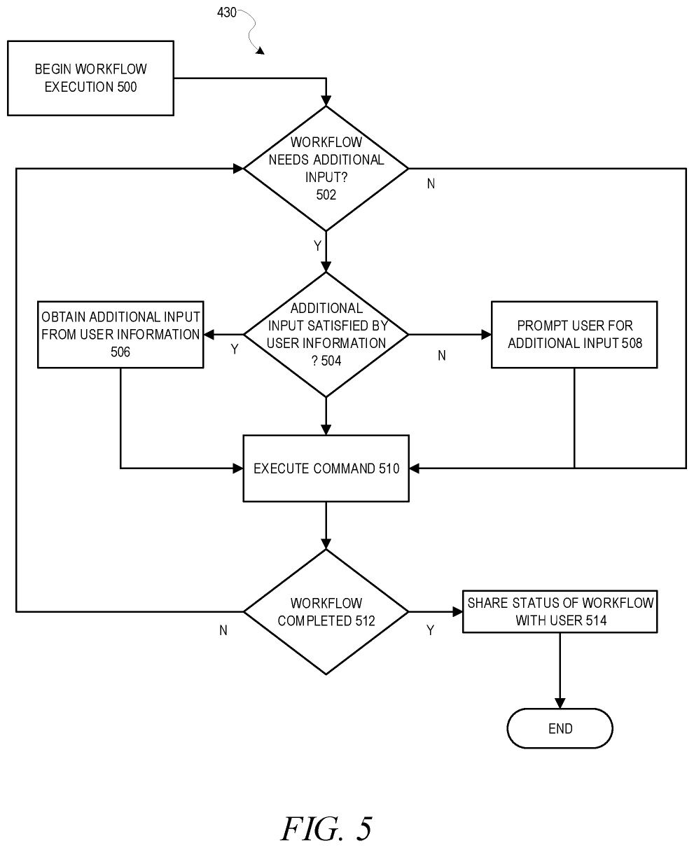

At operation 430, the virtual workflow or preliminary workflow, as the case may be, is executed. FIG. 5 is a flow diagram illustrating a method 430 for the execution of a virtual workflow or preliminary workflow, in accordance with an example embodiment, in more detail. At operation 500, workflow execution is begun. At operation 502, it is determined if the workflow needs additional input. If so, then at operation 504, is determined if the additional input may be satisfied using information already known about the user (such as that stored in a user profile). If so, then the additional input is obtained from that information at operation 506. An example might be a shipping address stored in a user profile. If additional input is needed that cannot be satisfied using information already known about the user, then at operation 508, the user is prompted to enter the additional input. In an example embodiment, this prompting may occur via the conversational artificial intelligence device. Specifically, the request for additional user input may be sent in the form of natural language text to the conversational artificial intelligence device, which converts it to spoken data and speaks it to the user. The user may then speak back to the conversational artificial intelligence device and have the additional input converted to natural language text for providing to the workflow.

Once all required information has been obtained, at operation 510, the command may be executed. This may include creating one or more system objects (such as purchase orders, approvals, etc.). At operation 512, it is determined if the workflow has been completed. If not, then the method 430 returns to operation 502. If so, then at operation 514, the status of the workflow (completed) is shared with the user.

Returning to FIG. 4, at operation 432, it is determined if the workflow that was executed was a preliminary workflow. If so, then at operation 434, the preliminary workflow is saved as a virtual workflow in a virtual workflow repository.

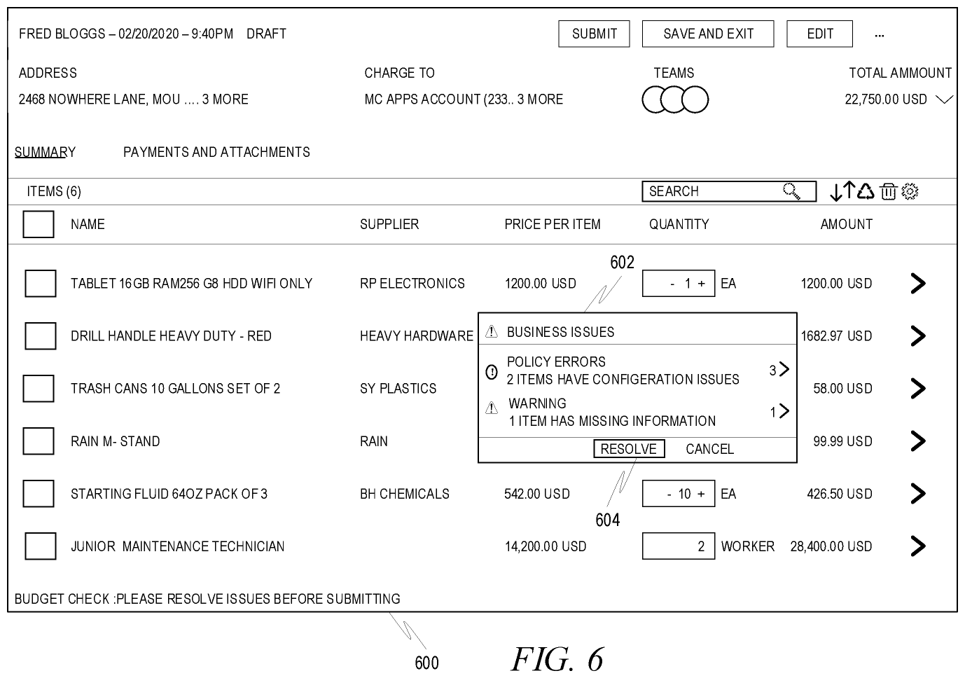

FIGS. 6-10 depict a user interface that can utilize the above techniques to provide interactive support for a user needing to fix items in a workflow. Specifically, a user may initiate a requisition or purchase using a user interface. Then the workflow may be executed and issues with the workflow may be identified. FIG. 6 is a diagram illustrating a screen capture of a user interface 600 having a pop-up window 602 describing issues with the workflow that the user needs to remedy, in accordance with an example embodiment. This includes 2 policy errors and one missing information warning. A button 604 allows the system to launch windows to address each of these issues.

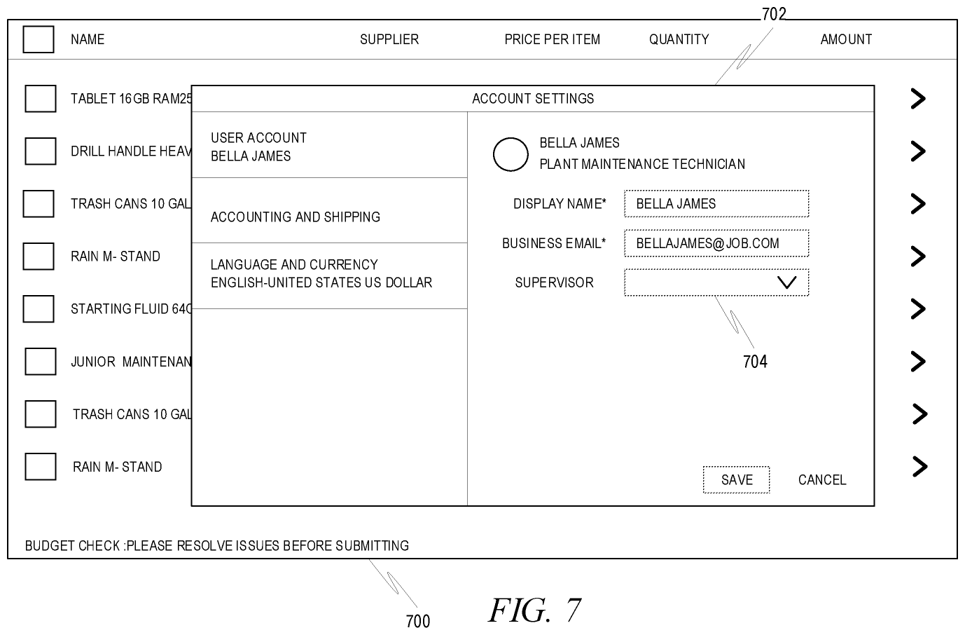

FIG. 7 is a diagram illustrating a screen capture of a user interface 700 having a pop-up window 702 allowing the user to enter more account settings, in accordance with an example embodiment. More particularly, the user needs to enter a supervisor in field 704 in order for the workflow issue to be addressed.

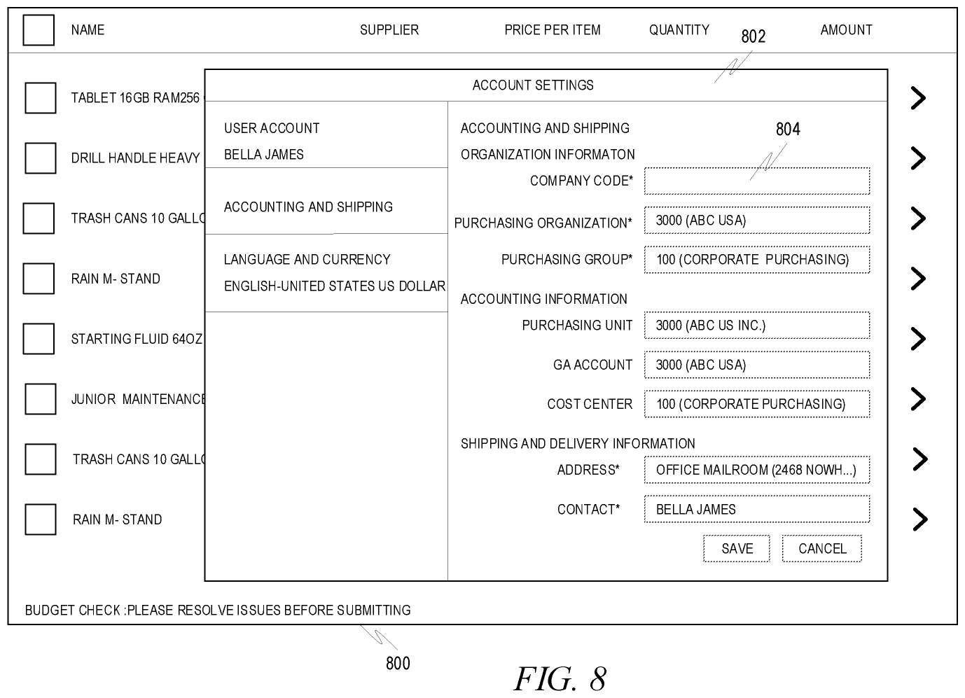

FIG. 8 is a diagram illustrating a screen capture of a user interface 800 having a pop-up window 802 allowing the user to enter additional account settings, in accordance with an example embodiment. Here, the user needs to enter a company code in field 804 in order for the workflow issue to be addressed.

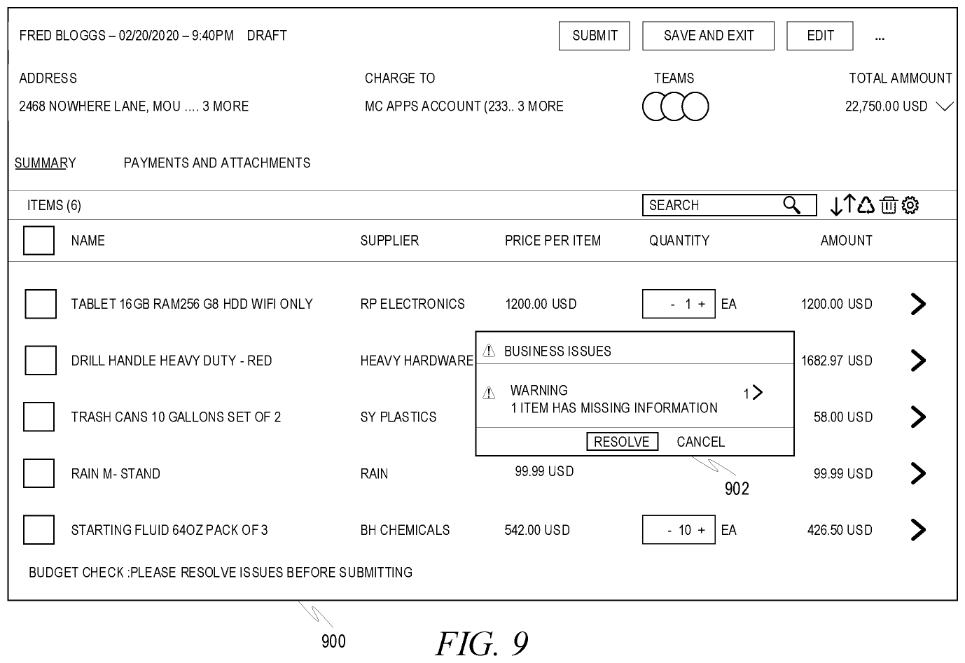

Once these two issues have been addressed, then all that is left is the missing information warning. FIG. 9 is a diagram illustrating a screen capture of a user interface 900 having a pop-up window 902 describing the remaining issue, in accordance with an example embodiment.

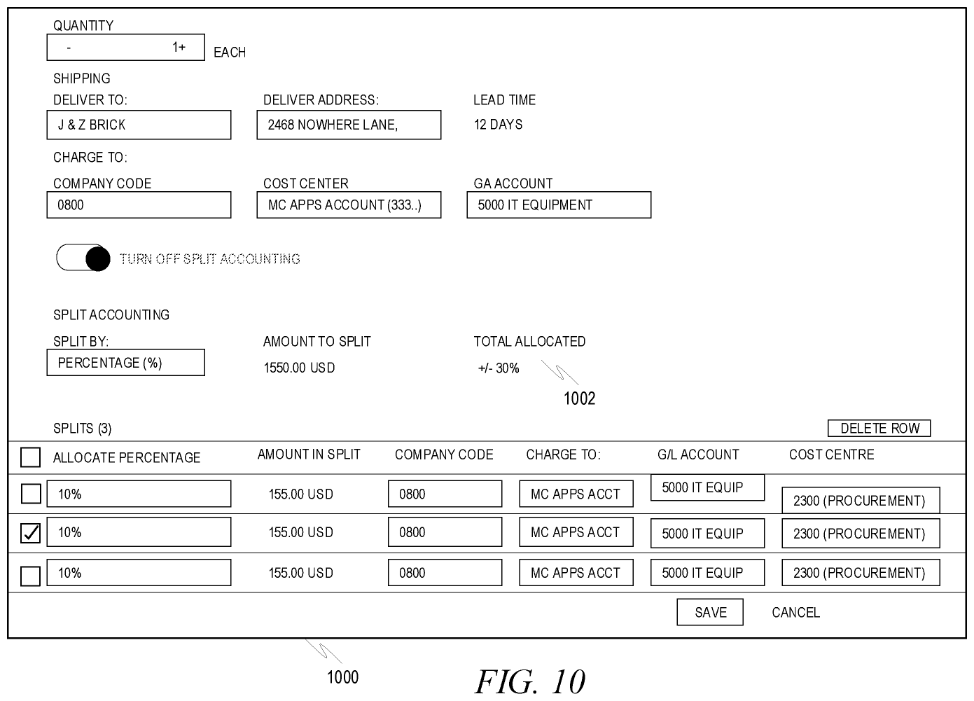

FIG. 10 is a diagram illustrating a screen capture of a user interface 1000 where the user can enter additional missing information, in accordance with an example embodiment. More particularly, here the user has not fully allocated the amount of the purchase/requisition in a split accounting scenario. More particularly, field 1002 indicates that the total allocated is only 30%. This screen allows the user to adjust the allocation percentage in fields such as field 1004 to make the total allocated amount be 100% to remove the error.

In view of the disclosure above, various examples are set forth below. It should be noted that one or more features of an example, taken in isolation or combination, should be considered within the disclosure of this application.

Example 1. A system comprising:

at least one hardware processor; and

a computer-readable medium storing instructions that, when executed by the at least one hardware processor, cause the at least one hardware processor to perform operations comprising:

receiving natural language text data associated with a software agent;

retrieving a natural language processor associated with the software agent, the natural language processor trained by feeding a first set of labeled training data into a first machine learning algorithm;

applying the natural language processor associated with the software agent to the natural language text data to assign a meaning to the natural language text data, the meaning including at least a subject, a command, and an object to which the command applies;

accessing an interaction graph corresponding to the command, the interaction graph including a plurality of nodes and edges connecting nodes in the plurality of nodes, each node representing an entity and each edge representing an interaction between entities at either end of the edge;

identifying a first node corresponding to the subject and a second node corresponding to the object, in the accessed interaction graph;

creating a preliminary workflow including the first node and the second node and also containing all nodes and edges between the nodes corresponding to the subject and the object in the obtained interaction graph; and

executing the preliminary workflow.

Example 2. The system of Example 1, wherein the interaction graph is created using an artificial intelligence engine, which obtains one or more user stories from a requirement management tool, derives a context for each user story, and creates interaction graphs based on the user stories.

Example 3. The system of Examples 1 or 2, wherein the natural language text data is retrieved from a conversational artificial intelligence device, which converts spoken data into the natural language text data.

Example 4. The system of Example 3, wherein the executing the preliminary workflow includes prompting the conversational artificial intelligence device for information from a user, for at least one interaction in the preliminary workflow.

Example 5. The system of Example 4, wherein the executing the preliminary workflow further includes automatically obtaining information about a user from a user profile, for at least one interaction in the preliminary workflow.

Example 6. The system of Example 2, wherein the artificial intelligence engine is a machine learned model trained by feeding a second set of labeled training data into a second machine learning algorithm.

Example 7. The system of any of Examples 1-6, wherein the operations further comprise identifying a persona for the user based on the meaning and based on information about the user, and wherein the obtaining an interaction graph includes obtaining an interaction graph corresponding to the command and to the persona.

Example 8. A method comprising:

receiving natural language text data associated with a software agent;

retrieving a natural language processor associated with the software agent, the natural language processor trained by feeding a first set of labeled training data into a first machine learning algorithm;

applying the natural language processor associated with the software agent to the natural language text data to assign a meaning to the natural language text data, the meaning including at least a subject, a command, and an object to which the command applies;

accessing an interaction graph corresponding to the command, the interaction graph including a plurality of nodes and edges connecting nodes in the plurality of nodes, each node representing an entity and each edge representing an interaction between entities at either end of the edge;

identifying a first node corresponding to the subject and a second node corresponding to the object, in the accessed interaction graph;

creating a preliminary workflow including the first node and the second node and also containing all nodes and edges between the nodes corresponding to the subject and the object in the obtained interaction graph; and

executing the preliminary workflow.

Example 9. The method of Example 8, wherein the interaction graph is created using an artificial intelligence engine, which obtains one or more user stories from a requirement management tool, derives a context for each user story, and creates interaction graphs based on the user stories.

Example 10. The method of Examples 8 or 9, wherein the natural language text data is retrieved from a conversational artificial intelligence device, which converts spoken data into the natural language text data.

Example 11. The method of Example 10, wherein the executing the preliminary workflow includes prompting the conversational artificial intelligence device for information from a user, for at least one interaction in the preliminary workflow.

Example 12. The method of Example 11, wherein the executing the preliminary workflow further includes automatically obtaining information about a user from a user profile, for at least one interaction in the preliminary workflow.

Example 13. The method of Example 9, wherein the artificial intelligence engine is a machine learned model trained by feeding a second set of labeled training data into a second machine learning algorithm.

Example 14. The method of any of Examples 8-13, further comprising identifying a persona for the user based on the meaning and based on information about the user, and wherein the obtaining an interaction graph includes obtaining an interaction graph corresponding to the command and to the persona.

Example 15. A non-transitory machine-readable medium storing instructions which, when executed by one or more processors, cause the one or more processors to perform operations comprising:

receiving natural language text data associated with a software agent;

retrieving a natural language processor associated with the software agent, the natural language processor trained by feeding a first set of labeled training data into a first machine learning algorithm;

applying the natural language processor associated with the software agent to the natural language text data to assign a meaning to the natural language text data, the meaning including at least a subject, a command, and an object to which the command applies;

accessing an interaction graph corresponding to the command, the interaction graph including a plurality of nodes and edges connecting nodes in the plurality of nodes, each node representing an entity and each edge representing an interaction between entities at either end of the edge;

identifying a first node corresponding to the subject and a second node corresponding to the object, in the obtained interaction graph;

creating a preliminary workflow including the first node and the second node and also containing all nodes and edges between the nodes corresponding to the subject and the object in the accessed interaction graph; and

executing the preliminary workflow.

Example 16. The non-transitory machine-readable medium of Example 15, wherein the interaction graph is created using an artificial intelligence engine, which obtains one or more user stories from a requirement management tool, derives a context for each user story, and creates interaction graphs based on the user stories.

Example 17. The non-transitory machine-readable medium of Examples 15 or 16, wherein the natural language text data is retrieved from a conversational artificial intelligence device, which converts spoken data into the natural language text data.

Example 18. The non-transitory machine-readable medium of Example 17, wherein the executing the preliminary workflow includes prompting the conversational artificial intelligence device for information from a user, for at least one interaction in the preliminary workflow.

Example 19. The non-transitory machine-readable medium of Example 18, wherein the executing the preliminary workflow further includes automatically obtaining information about a user from a user profile, for at least one interaction in the preliminary workflow.

Example 20. The non-transitory machine-readable medium of Example 16, wherein the artificial intelligence engine is a machine learned model trained by feeding a second set of labeled training data into a second machine learning algorithm.

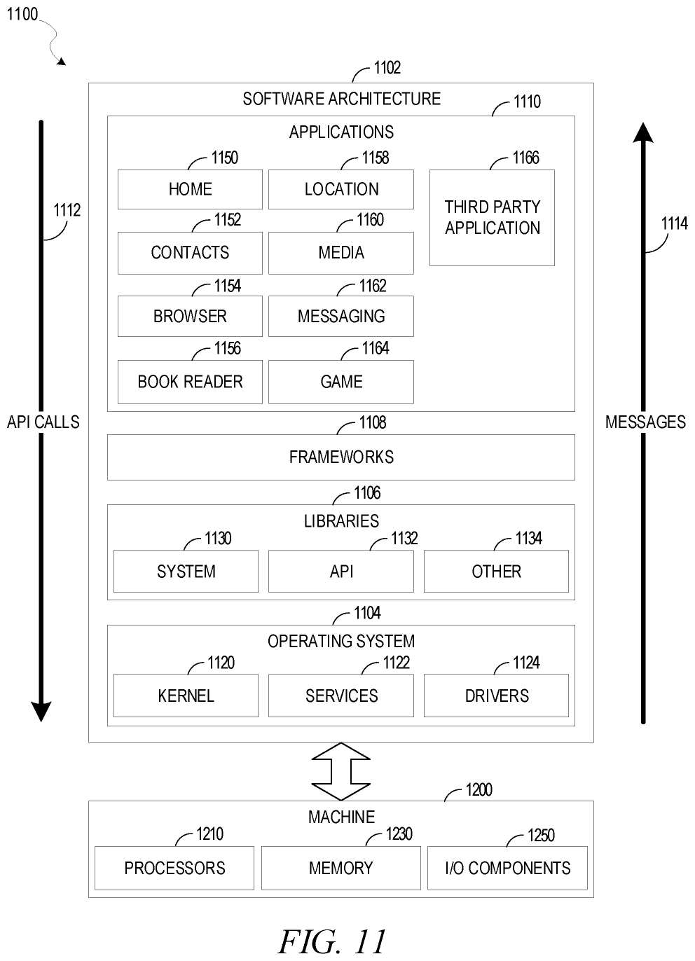

FIG. 11 is a block diagram 1100 illustrating a software architecture 1102, which can be installed on any one or more of the devices described above. FIG. 11 is merely a non-limiting example of a software architecture, and it will be appreciated that many other architectures can be implemented to facilitate the functionality described herein. In various embodiments, the software architecture 1102 is implemented by hardware such as a machine 700 of FIG. 7 that includes processors 710, memory 730, and input/output (I/O) components 750. In this example architecture, the software architecture 1102 can be conceptualized as a stack of layers where each layer may provide a particular functionality. For example, the software architecture 1102 includes layers such as an operating system 1104, libraries 1106, frameworks 1108, and applications 1110. Operationally, the applications 1110 invoke Application Program Interface (API) calls 1112 through the software stack and receive messages 1114 in response to the API calls 1112, consistent with some embodiments.

In various implementations, the operating system 1104 manages hardware resources and provides common services. The operating system 1104 includes, for example, a kernel 1120, services 1122, and drivers 1124. The kernel 1120 acts as an abstraction layer between the hardware and the other software layers, consistent with some embodiments. For example, the kernel 1120 provides memory management, processor management (e.g., scheduling), component management, networking, and security settings, among other functionality. The services 1122 can provide other common services for the other software layers. The drivers 1124 are responsible for controlling or interfacing with the underlying hardware, according to some embodiments. For instance, the drivers 1124 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 1106 provide a low-level common infrastructure utilized by the applications 1110. The libraries 1106 can include system libraries 1130 (e.g., C standard library) that can provide functions such as memory allocation functions, string manipulation functions, mathematic functions, and the like. In addition, the libraries 1106 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 1106 can also include a wide variety of other libraries 1134 to provide many other APIs to the applications 1110.

The frameworks 1108 provide a high-level common infrastructure that can be utilized by the applications 1110, according to some embodiments. For example, the frameworks 1108 provide various graphical user interface (GUI) functions, high-level resource management, high-level location services, and so forth. The frameworks 1108 can provide a broad spectrum of other APIs that can be utilized by the applications 1110, some of which may be specific to a particular operating system 1104 or platform.

In an example embodiment, the applications 1110 include a home application 1150, a contacts application 1152, a browser application 1154, a book reader application 1156, a location application 1158, a media application 1160, a messaging application 1162, a game application 1164, and a broad assortment of other applications, such as a third-party application 1166. According to some embodiments, the applications 1110 are programs that execute functions defined in the programs. Various programming languages can be employed to create one or more of the applications 1110, structured in a variety of manners, such as object-oriented programming languages (e.g., Objective-C, Java, or C++) or procedural programming languages (e.g., C or assembly language). In a specific example, the third-party application 1166 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1166 can invoke the API calls 1112 provided by the operating system 1104 to facilitate functionality described herein.

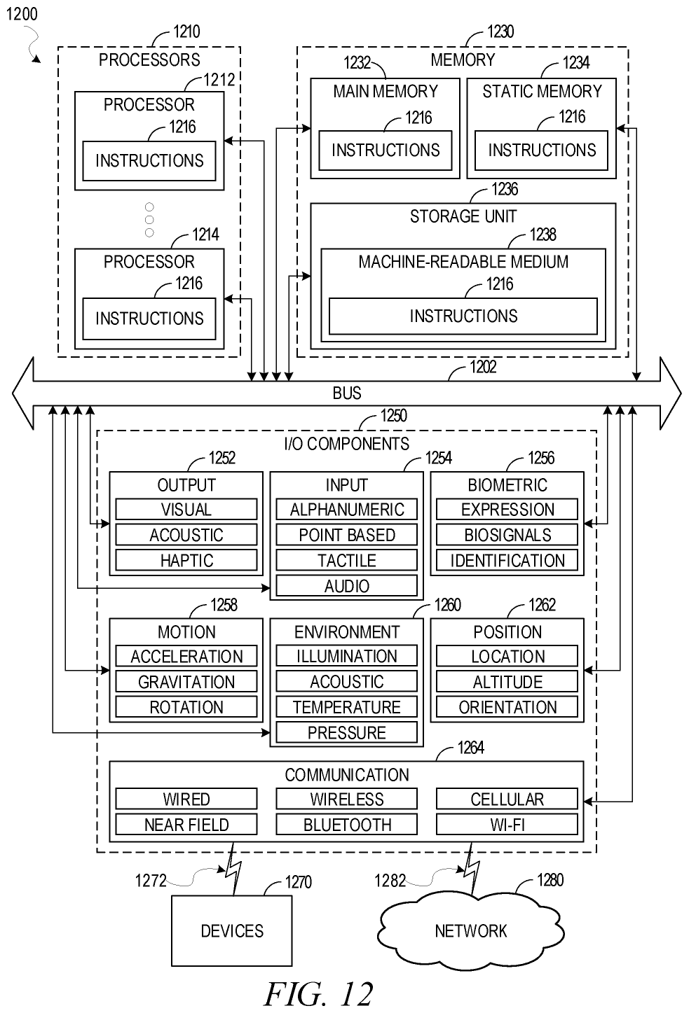

FIG. 12 illustrates a diagrammatic representation of a machine 1200 in the form of a computer system within which a set of instructions may be executed for causing the machine 1200 to perform any one or more of the methodologies discussed herein, according to an example embodiment. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example, the instructions 1216 may cause the machine 1200 to execute the methods of FIGS. 4 and 5. Additionally, or alternatively, the instructions 1216 may implement FIGS. 1-5 and so forth. The instructions 1216 transform the general, non-programmed machine 1200 into a particular machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by the machine 1200. Further, while only a single machine 1200 is illustrated, the term “machine” shall also be taken to include a collection of machines 1200 that individually or jointly execute the instructions 1216 to perform any one or more of the methodologies discussed herein.

The machine 1200 may include processors 1210, memory 1230, and I/O components 1250, which may be configured to communicate with each other such as via a bus 1202. In an example embodiment, the processors 1210 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1212 and a processor 1214 that may execute the instructions 1216. The term “processor” is intended to include multi-core processors that may comprise two or more independent processors (sometimes referred to as “cores”) that may execute instructions 1216 contemporaneously. Although FIG. 12 shows multiple processors 1210, the machine 1200 may include a single processor 1212 with a single core, a single processor 1212 with multiple cores (e.g., a multi-core processor 1212), multiple processors 1212, 1214 with a single core, multiple processors 1212, 1214 with multiple cores, or any combination thereof.

The memory 1230 may include a main memory 1232, a static memory 1234, and a storage unit 1236, each accessible to the processors 1210 such as via the bus 1202. The main memory 1232, the static memory 1234, and the storage unit 1236 store the instructions 1216 embodying any one or more of the methodologies or functions described herein. The instructions 1216 may also reside, completely or partially, within the main memory 1232, within the static memory 1234, within the storage unit 1236, within at least one of the processors 1210 (e.g., within the processor's cache memory), or any suitable combination thereof, during execution thereof by the machine 1200.

The I/O components 1250 may include a wide variety of components to receive input, provide output, produce output, transmit information, exchange information, capture measurements, and so on. The specific I/O components 1250 that are included in a particular machine will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion, and the grouping is in no way limiting. In various example embodiments, the I/O components 1250 may include output components 1252 and input components 1254. The output components 1252 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environmental components 1260, or position components 1262, among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1258 may include acceleration sensor components (e.g., accelerometer), gravitation sensor components, rotation sensor components (e.g., gyroscope), and so forth. The environmental components 1260 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1262 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via a coupling 1282 and a coupling 1272, respectively. For example, the communication components 1264 may include a network interface component or another suitable device to interface with the network 1280. In further examples, the communication components 1264 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., coupled via a USB).

Moreover, the communication components 1264 may detect identifiers or include components operable to detect identifiers. For example, the communication components 1264 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as location via Internet Protocol (IP) geolocation, location via Wi-Fi® signal triangulation, location via detecting an NFC beacon signal that may indicate a particular location, and so forth.

The various memories (i.e., 1230, 1232, 1234, and/or memory of the processor(s) 1210) and/or the storage unit 1236 may store one or more sets of instructions 1216 and data structures (e.g., software) embodying or utilized by any one or more of the methodologies or functions described herein. These instructions (e.g., the instructions 1216), when executed by the processor(s) 1210, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1280 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1280 or a portion of the network 1280 may include a wireless or cellular network, and the coupling 1282 may be a Code Division Multiple Access (CDMA) connection, a Global System for Mobile communications (GSM) connection, or another type of cellular or wireless coupling. In this example, the coupling 1282 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1216 may be transmitted or received over the network 1280 using a transmission medium via a network interface device (e.g., a network interface component included in the communication components 1264) and utilizing any one of a number of well-known transfer protocols (e.g., Hypertext Transfer Protocol (HTTP)). Similarly, the instructions 1216 may be transmitted or received using a transmission medium via the coupling 1272 (e.g., a peer-to-peer coupling) to the devices 1270. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1216 for execution by the machine 1200, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving natural language text data associated with a software agent;
retrieving a natural language processor associated with the software agent, the natural language processor trained by feeding a first set of labeled training data into a first machine learning algorithm;
applying the natural language processor associated with the software agent to the natural language text data to assign a meaning to the natural language text data, the meaning including at least a subject, a command, and an object to which the command applies;
accessing an interaction graph corresponding to the command, the interaction graph including a plurality of nodes and edges connecting nodes in the plurality of nodes, each node representing an entity and each edge representing an interaction between entities at either end of the edge;
identifying a first node corresponding to the subject and a second node corresponding to the object, in the accessed interaction graph;
creating a preliminary workflow including the first node and the second node and also containing all nodes and edges between the nodes corresponding to the subject and the object in the obtained interaction graph; and
executing the preliminary workflow.

2. The system of claim 1, wherein the interaction graph is created using an artificial intelligence engine, which obtains one or more user stories from a requirement management tool, derives a context for each user story, and creates interaction graphs based on the user stories.

3. The system of claim 1, wherein the natural language text data is retrieved from a conversational artificial intelligence device, which converts spoken data into the natural language text data.

4. The system of claim 3, wherein the executing the preliminary workflow includes prompting the conversational artificial intelligence device for information from a user, for at least one interaction in the preliminary workflow.

5. The system of claim 4, wherein the executing the preliminary workflow further includes automatically obtaining information about a user from a user profile, for at least one interaction in the preliminary workflow.

6. The system of claim 2, wherein the artificial intelligence engine is a machine learned model trained by feeding a second set of labeled training data into a second machine learning algorithm.

7. The system of claim 1, wherein the operations further comprise identifying a persona for the user based on the meaning and based on information about the user; and
wherein the obtaining an interaction graph includes obtaining an interaction graph corresponding to the command and to the persona.

8. A method comprising:
receiving natural language text data associated with a software agent;
retrieving a natural language processor associated with the software agent, the natural language processor trained by feeding a first set of labeled training data into a first machine learning algorithm;
applying the natural language processor associated with the software agent to the natural language text data to assign a meaning to the natural language text data, the meaning including at least a subject, a command, and an object to which the command applies;
accessing an interaction graph corresponding to the command, the interaction graph including a plurality of nodes and edges connecting nodes in the plurality of nodes, each node representing an entity and each edge representing an interaction between entities at either end of the edge;
identifying a first node corresponding to the subject and a second node corresponding to the object, in the accessed interaction graph;
creating a preliminary workflow including the first node and the second node and also containing all nodes and edges between the nodes corresponding to the subject and the object in the obtained interaction graph; and
executing the preliminary workflow.

9. The method of claim 8, wherein the interaction graph is created using an artificial intelligence engine, which obtains one or more user stories from a requirement management tool, derives a context for each user story, and creates interaction graphs based on the user stories.

10. The method of claim 8, wherein the natural language text data is retrieved from a conversational artificial intelligence device, which converts spoken data into the natural language text data.

11. The method of claim 10, wherein the executing the preliminary workflow includes prompting the conversational artificial intelligence device for information from a user, for at least one interaction in the preliminary workflow.

12. The method of claim 11, wherein the executing the preliminary workflow further includes automatically obtaining information about a user from a user profile, for at least one interaction in the preliminary workflow.

13. The method of claim 9, wherein the artificial intelligence engine is a machine learned model trained by feeding a second set of labeled training data into a second machine learning algorithm.

14. The method of claim 8, further comprising identifying a persona for the user based on the meaning and based on information about the user; and
wherein the obtaining an interaction graph includes obtaining an interaction graph corresponding to the command and to the persona.

15. A non-transitory machine-readable medium storing instructions which, when executed by one or more processors, cause the one or more processors to perform operations comprising:
receiving natural language text data associated with a software agent;
retrieving a natural language processor associated with the software agent, the natural language processor trained by feeding a first set of labeled training data into a first machine learning algorithm;
applying the natural language processor associated with the software agent to the natural language text data to assign a meaning to the natural language text data, the meaning including at least a subject, a command, and an object to which the command applies;
accessing an interaction graph corresponding to the command, the interaction graph including a plurality of nodes and edges connecting nodes in the plurality of nodes, each node representing an entity and each edge representing an interaction between entities at either end of the edge;
identifying a first node corresponding to the subject and a second node corresponding to the object, in the obtained interaction graph;
creating a preliminary workflow including the first node and the second node and also containing all nodes and edges between the nodes corresponding to the subject and the object in the accessed interaction graph; and
executing the preliminary workflow.

16. The non-transitory machine-readable medium of claim 15, wherein the interaction graph is created using an artificial intelligence engine, which obtains one or more user stories from a requirement management tool, derives a context for each user story, and creates interaction graphs based on the user stories.

17. The non-transitory machine-readable medium of claim 15, wherein the natural language text data is retrieved from a conversational artificial intelligence device, which converts spoken data into the natural language text data.

18. The non-transitory machine-readable medium of claim 17, wherein the executing the preliminary workflow includes prompting the conversational artificial intelligence device for information from a user, for at least one interaction in the preliminary workflow.

19. The non-transitory machine-readable medium of claim 18, wherein the executing the preliminary workflow further includes automatically obtaining information about a user from a user profile, for at least one interaction in the preliminary workflow.

20. The non-transitory machine-readable medium of claim 16, wherein the artificial intelligence engine is a machine learned model trained by feeding a second set of labeled training data into a second machine learning algorithm.
